(19) United States
(12) Patent Application Publication
(10) Pub. No.: US 2025/0074414 A1
(43) Pub. Date: Mar. 6, 2025

(54) DRIVING ASSISTANCE DEVICE FOR A VEHICLE

(71) Applicant: TOYOTA JIDOSHA KABUSHIKI KAISHA, Toyota-shi (JP)

(72) Inventors: Yuki MINASE, Toyota-shi (JP); Masayuki Shakutsui, Nisshin-shi (JP)

(73) Assignee: TOYOTA JIDOSHA KABUSHIKI KAISHA, Toyota-shi (JP)

(21) Appl. No.: 18/819,690

(22) Filed: Aug. 29, 2024

(30) Foreign Application Priority Data
Sep. 4, 2023 (JP) 2023-143169

(51) Int. Cl. B60W 30/14

(52) U.S. Cl. CPC B60W 30/146; B60W 2520/00; B60W 2556/10; B60W 2556/50; B60W 2720/10

(57) ABSTRACT

A driving assistance device that stores information about a running route of a vehicle driven by a driver in a storage device, and when the driver issues an automatic running command, sets a target running route based on the information on the running route stored in the storage device, and controls a running control device so that the vehicle drives by automatic running along the target running route, and the driving assistance device, when a vertical acceleration magnitude equal to or greater than a reference value is detected while the vehicle is driven by the driver, stores the position where the high vertical acceleration magnitude is detected in the storage device as a specific point of road surface displacement together with information on the running route, and reduces a vehicle speed when the vehicle passes a position corresponding to the specific point during the automatic running.

### CROSS-REFERENCE TO RELATED APPLICATION

This application claims priority to Japanese Patent Application No. JP2023-143169 filed on Sep. 4, 2023, the content of which is hereby incorporated by reference in its entirety into this application.

### BACKGROUND

### 1. Technical Field

The present disclosure relates to a driving assistance device for a vehicle such as an automobile.

### 2. Description of the Related Art

As one of driving assistance devices for vehicles such as automobiles, there is known a driving assistance device that records a running route of a vehicle driven by a driver and assist the driver in driving the vehicle along the recorded running route during subsequent driving.

For example, Japanese Patent No. 06022447 describes a driving assistance device that has a learning mode that records a running route and a stopping position of a vehicle driven by a driver, and during driving assistance, automatically moves the vehicle along the recorded running route to the stopping position.

During the driving assistance, information on surroundings of the vehicle is acquired by surrounding information acquisition devices such as camera sensors and radar sensors to prevent the vehicle from colliding with obstacles. Although the surrounding information acquisition devices can detect obstacles such as stopped vehicles, they may not be able to detect a point where a road surface changes suddenly vertically, such as a speed bump, a step, and a groove (referred to as “specific point”).

When a vehicle passes over a specific point during the driving assistance, an impact load is input from a road surface to a vehicle body via wheels, causing the vehicle body to vibrate. Therefore, in conventional driving assistance devices such as the driving assistance device described in the above Japanese Patent, it is inevitable that occupants feel uncomfortable due to the vibration of the vehicle body when the vehicle passes through the specific point.

The present disclosure provides an improved driving assistance device that reduces a degree of vibration of a vehicle body as compared to conventional devices, thereby reducing a risk of occupants feeling uncomfortable, even when a vehicle passes through a specific point while automatically running along a recorded running route.

### SUMMARY

The present disclosure provides a driving assistance device for a vehicle, comprising a route information acquisition device that acquires information on a running route along which the vehicle is driven by a driver from an information acquisition start position to an information acquisition end position based on an information acquisition command from the driver; a storage device that stores the information on the running route acquired by the route information acquisition device; a running control device that controls running of the vehicle; and an electronic control unit that controls the route information acquisition device, the storage device, and the running control device, and the electronic control unit is configured, upon receiving an automatic running command from the driver, to set a target running route from a present position of the vehicle to a running end position based on the information on the running route stored in the storage device, and to control the running control device to move the vehicle by automatic running so that the vehicle runs along the target running route.

The driving assistance device includes a detection device that detects a vertical acceleration of the vehicle, and the electronic control unit is configured to, when the detection device detects a magnitude of the vertical acceleration equal to or greater than a reference value while the vehicle is being driven by a driver, store a position where the magnitude of the vertical acceleration equal to or greater than the reference value is detected in the storage device as a specific point of road surface displacement together with information on the running route, and to control the running control device so that a vehicle speed is reduced when the vehicle passes through a position corresponding to the specific point during the automatic running.

According to the present disclosure, when a specific point is present, the vehicle speed is reduced when the vehicle passes through a position corresponding to the specific point during the automatic running. Therefore, as compared to where the vehicle speed is not reduced, an impact load input from a road surface to a vehicle body via wheels when the vehicle passes through the positon corresponding to the specific point is reduced, and a degree of vibration of the vehicle body is reduced. As a result, the risk of occupants feeling uncomfortable due to the vibration of the vehicle body can be reduced as compared to conventional devices.

In one aspect of the present disclosure, the reference value is variably set according to the vehicle speed so that the higher the vehicle speed when the vehicle is driven by the driver, the larger the reference value becomes.

Since an impact load input to the vehicle body when the vehicle passes through a specific point increases as the vehicle speed increases, a vertical acceleration of the vehicle when the vehicle passes through the specific point increases as the vehicle speed increases. Therefore, it is preferable that the reference value for determining a magnitude of the vertical acceleration of the vehicle is larger as the vehicle speed increases.

According to the above aspect, the reference value is variably set according to the vehicle speed so that the higher the vehicle speed when the vehicle is driven by the driver, the larger the reference value becomes. Therefore, it is possible to preferably determine whether or not a vertical displacement of the road surface at the specific point is large, as compared to where the reference value is constant regardless of the vehicle speed.

In another aspect of the present disclosure, a reduction amount in vehicle speed when the vehicle passes through the position corresponding to the specific point during the automatic running is variably set according to at least one of the vehicle speed during the automatic running and the magnitude of the vertical acceleration of the vehicle detected by the detection device so that the reduction amount in vehicle speed is larger as the vehicle speed during the automatic running is higher and the magnitude of the vertical acceleration of the vehicle detected by the detection device is larger.

The impact load input to the vehicle body when the vehicle passes through the position corresponding to the specific point during the automatic running is greater the higher the vehicle speed, so it is preferable that the reduction amount in vehicle speed when the vehicle passes through the position corresponding to the specific point is greater the higher the vehicle speed during the automatic running. In addition, the impact load input to the vehicle body when the vehicle passes through the position corresponding to the specific point during the automatic running is greater as the magnitude of the vertical acceleration of the vehicle detected by the detection device is greater. Therefore, it is preferable that the reduction amount in vehicle speed when the vehicle passes through the point corresponding to the specific point is greater as the magnitude of the vertical acceleration of the vehicle detected by the detection device is greater.

According to the above aspect, the reduction amount in vehicle speed when the vehicle passes through the position corresponding to the specific point during the automatic running becomes greater the higher the vehicle speed during the automatic running and/or the greater the magnitude of the vertical acceleration of the vehicle detected by the detection device. Therefore, as compared to where the reduction amount in vehicle speed is constant, it is possible to preferably reduce the impact load input to the vehicle body when the vehicle passes through the position corresponding to the specific point.

Further, in another aspect of the present disclosure, the electronic control unit is configured to, when a running start position of the automatic running is not on the running route stored in the storage device, set the target running route to include a merging route from the running start position to the running route stored in the storage device.

According to the above aspect, when a running start position of the automatic running is not on the running route stored in the storage device, the target running route is set so as to include a merging route leading from the running start position to the running route stored in the storage device. Therefore, even if the running start position of the automatic running is not on the running route stored in the storage device, the vehicle can be moved to the running end position along the target running route by the automatic running.

Further, in another aspect of the present disclosure, the route information acquisition device includes a GPS device, and the electronic control unit is configured to identify at least an information acquisition start position based on a position of the vehicle acquired by the GPS device, and to identify the running route of the vehicle based on at least one of a track of the vehicle acquired by the GPS device and driving history of the driver.

According to the above aspect, the running route of the vehicle can be identified based on at least one of the track of the vehicle acquired by the GPS device and the driving history of the driver.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing a driving assistance device according to an embodiment of the present disclosure.

FIG. 2 is a flowchart showing a running route registration control in the embodiment.

FIG. 3 is a flowchart showing a driving assistance control in the embodiment.

FIG. 4A is a diagram showing an example of the running route registration control when a vehicle is parked.

FIG. 4B is a diagram showing an example of a vehicle speed when the vehicle is parked.

FIG. 4C is a diagram showing an example of a vertical acceleration of the vehicle when the vehicle is parked.

FIG. 5A is a diagram showing an example of driving assistance control when there is a specific point of road surface displacement and the vehicle is parked.

FIG. 5B is a diagram showing an example of a vehicle speed when there is a specific point of road surface displacement and the vehicle is parked.

FIG. 5C is a diagram showing an example of a vertical acceleration of the vehicle when there is a specific point of road surface displacement and the vehicle is parked.

FIG. 6A is a diagram showing an example of driving assistance control when there is no specific point of road surface displacement and the vehicle is parked.

FIG. 6B is a diagram showing an example of a vehicle speed when there is no specific point of road surface displacement and the vehicle is parked.

FIG. 6C is a diagram showing an example of a vertical acceleration of the vehicle when there is no specific point of road surface displacement and the vehicle is parked.

### DESCRIPTION OF THE PREFERRED EMBODIMENT

The driving assistance device according to the embodiment of the present disclosure will be described in detail below with reference to the accompanying drawings.

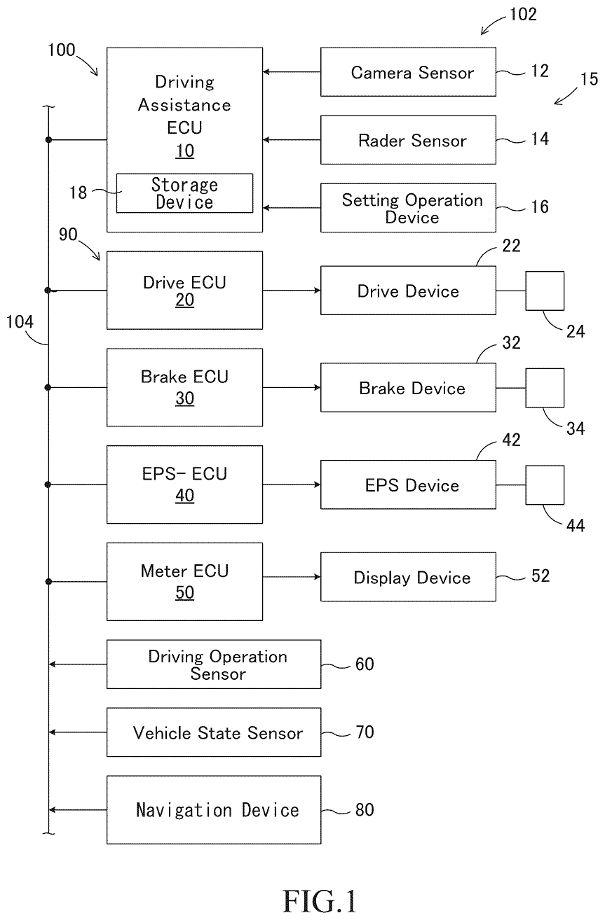

As shown in FIG. 1, a driving assistance device 100 according to the embodiment of the present disclosure is applied to a vehicle 102 and includes a driving assistance ECU 10. The vehicle 102 may be a vehicle capable of autonomous driving. As shown in FIG. 1, the vehicle 102 includes a drive ECU 20, a brake ECU 30, an electric power steering ECU 40, and a meter ECU 50. ECU means an electronic control unit having a microcomputer as its main part. In the following description, the electric power steering will be referred to as EPS.

A microcomputer of each ECU includes a CPU, a ROM, a RAM, a readable and writable nonvolatile memory (N/M), an interface (I/F), and the like. The CPU implements various functions by executing instructions (programs, routines) stored in the ROM. Furthermore, these ECUs are connected to each other via a CAN (Controller Area Network) 104 so as to be able to exchange data (communicate). Therefore, detected values of sensors (including switches) connected to a specific ECU are transmitted to other ECUs as well.

The driving assistance ECU 10 is a central control unit that performs driving assistance control for the vehicle such as the running route registration control, the driving assistance control, lane keeping control. In the embodiment, the driving assistance ECU 10 cooperates with other ECUs to perform the running route registration control and the driving assistance control for assisting parking of the vehicle 102, as will be described in detail later.

A camera sensor 12, a radar sensor 14 and a setting operation device 16 are connected to the driving assistance ECU 10. The camera sensor 12 and the radar sensor 14 include a plurality of camera devices and a plurality of radar devices, respectively. The camera sensor 12 and the radar sensor 14 function as a surrounding information acquisition device 15 that acquires information on targets around the vehicle 102. The driving assistance ECU 10 has a non-volatile storage device 18 built therein.

Although not shown in FIG. 1, each camera device of the camera sensor 12 includes a camera unit that captures images of surroundings of the vehicle 102, and a recognition unit that analyzes the image data captured by the camera unit and recognizes targets such as white lines on a road and other vehicles. The recognition unit supplies information on recognized targets to the driving assistance ECU 10 every time a predetermined time elapses.

Each radar device of the radar sensors 14 has a radar transmitting/receiving unit and a signal processor (not shown). The radar transmitting/receiving unit emits radio waves in a millimeter wave band (hereinafter referred to as “millimeter waves”) around the vehicle 102, and three-dimensional objects (for example, other vehicles, bycicles, etc.) existing within a radiation range, and receives reflected millimeter waves (i.e., reflected waves). Based on a phase difference between the emitted millimeter wave and the received reflected wave, an attenuation level of the reflected wave, and a time from when the millimeter wave is emitted to when the reflected wave is received, the signal processing unit acquires every predetermined time information concerning a relative distance and a relative speed between the own vehicle and a three-dimensional object, a relative position (direction) of the three-dimensional object with respect to the own vehicle, and the like, and supplies the information to the driving assistance ECU 10. LiDAR (Light Detection And Ranging) may be used instead of or in addition to the radar sensor 14.

The setting operation device 16 is provided at a position operable by a driver, such as on a steering wheel (not shown in FIG. 1), and is adapted to be operated by the driver. Although not shown in FIG. 1, the setting operation device 16 includes a running route registration switch and a driving assistance switch. As will be described in detail later, the driving assistance ECU 10 executes the running route registration control when the running route registration switch is on, and executes the driving assistance control when the driving assistance switch is on.

The drive ECU 20 is connected to a drive device 22 that accelerates the vehicle 102 by applying driving force to drive wheels 24. The drive ECU 20 normally controls the drive device 22 so that the driving force generated by the drive device 22 changes according to a driving operation by the driver, and when the drive ECU 20 receives a command signal from the driving assistance ECU 10, the drive ECU 20 controls the drive device 22 based on the command signal.

The brake ECU 30 is connected to a brake device 32 that decelerates the vehicle 102 by applying braking force to wheels 34. The brake ECU 30 normally controls the brake device 32 so that the braking force generated by the brake device 32 changes according to a braking operation by the driver, and, when the brake ECU 30 receives a command signal from the driving assistance ECU 10, the brake ECU 30 performs automatic braking by controlling the brake device 32 based on a command signal. Therefore, the brake ECU 30 and the brake device 32 function as an automatic brake device. When braking force is applied to the wheels, brake lights (not shown in FIG. 1) are turned on.

The EPS-ECU 40 is connected to an EPS device 42. The EPS-ECU 40 controls the EPS device 42 in a manner known in the art based on a steering torque Ts and a vehicle speed V detected by a driving operation sensor 60 and a vehicle state sensor 70, which will be described later, to control a steering torque and reduce the driver's steering burden. Further, the EPS-ECU 40 can steer steered wheels 44 as necessary by controlling the EPS device 42. Therefore, the EPS-ECU 40 and the EPS device 42 function as an automatic steering device 46 that automatically steers the steered wheels 44 as necessary.

As can be seen from the above description, the drive ECU 20, the drive device 22, the brake ECU 30, the brake device 32, the EPS-ECU 40 and the EPS device 42 function as a running control device 90 that controls running of the vehicle 102, such as braking/driving and turning.

The meter ECU 50 is connected to a touch panel type display device 52 that displays status of the control by the driving assistance ECU 10 and the like. The display device 52 may be, for example, a multi-information display on which meters and various pieces of information are displayed, or may be a display of a navigation device described below.

The driving operation sensor 60 and the vehicle state sensor 70 are connected to the CAN 104. Information detected by the driving operation sensor 60 and the vehicle state sensor 70 (referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 60 includes a driving operation amount sensor that detects an operation amount of an accelerator pedal, a braking operation amount sensor that detects a master cylinder pressure or a pressing force on a brake pedal, and a brake switch that detects whether or not the brake pedal is operated. Further, the driving operation sensor 60 includes a steering angle sensor that detects a steering angle θ, and a steering torque sensor that detects a steering torque Ts, and the like.

The vehicle state sensor 70 includes a vehicle speed sensor that detects a vehicle speed V of the vehicle 102, a longitudinal acceleration sensor that detects a longitudinal acceleration of the vehicle, a lateral acceleration sensor that detects a lateral acceleration of the vehicle, and a vertical acceleration sensor that detects a vertical acceleration Gz of the vehicle, and the like.

Furthermore, a navigation device 80 is also connected to the CAN 104. The navigation device 80 includes a GPS receiver that detects a position of the vehicle 102, a storage device that stores map information and road information, and a communication device that acquires a latest map information and road information from outside. The navigation device 80 functions as a GPS device that acquires information on a present position of the vehicle 102, and outputs a signal indicating the present position of the vehicle on a map to the driving assistance ECU 10.

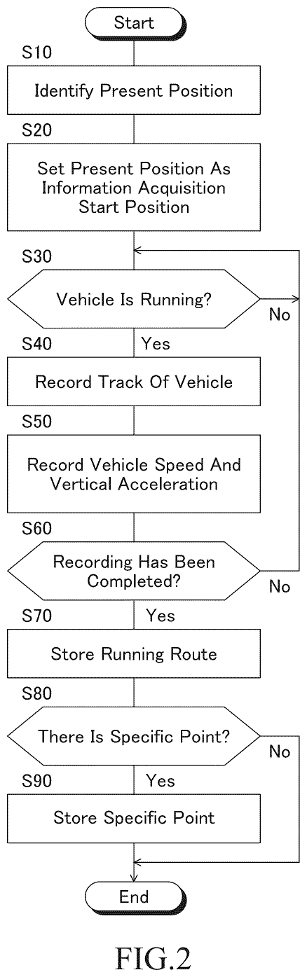

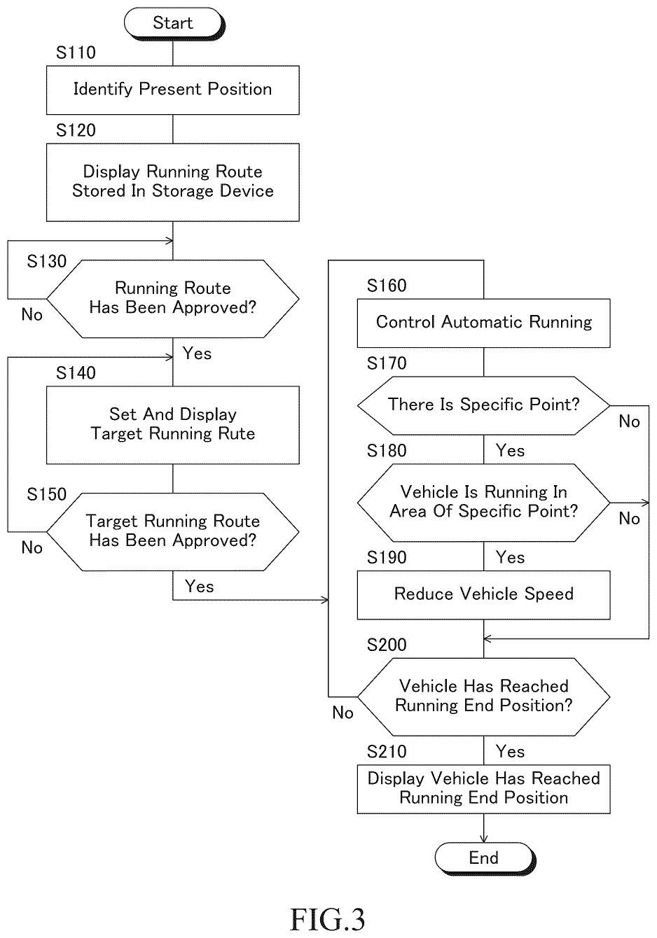

In the embodiment, the ROM of the driving assistance ECU 10 stores a running route registration control program corresponding to the flowchart shown in FIG. 2 and a driving assistance control program corresponding to the flowchart shown in FIG. 3. The CPU of the driving assistance ECU 10 performs driving assistance by executing the running route registration control and the driving assistance control in accordance with these programs.

### <Running Route Registration Control (FIG. 2)>

Next, the running route registration control in this embodiment will be described with reference to the flowchart shown in FIG. 2. The running route registration control according to the flowchart shown in FIG. 2 is started by the CPU of the driving assistance ECU 10 when the running route registration switch of the setting operation device 16 shown in FIG. 1 is turned from off to on, that is, when the driver has issued a command to obtain information.

First, in step S10, the CPU identifies a present position (latitude and longitude) of the vehicle 102 based on information from the navigation device 80.

In step S20, the CPU sets the present position of the vehicle 102 as a information acquisition start position for acquiring information on the running route to be recorded.

In step S30, the CPU determines whether or not the vehicle 102 is running by, for example, determining whether or not a shift position of a transmission (not shown) is in D range. When a negative determination is made, step S30 is repeatedly executed, and when an affirmative determination is made, the control proceeds to step S40.

In step S40, the CPU records a track of the vehicle 102 in the RAM as parking running route information based on a signal from the navigation device 80. The CPU also records surrounding information such as scenery around the vehicle 102 in the RAM as running route information based on a signal supplied from the surrounding information acquisition device 15 at predetermined time intervals. Therefore, the navigation device 80 and the surrounding information acquisition device 15 function as a running route information acquisition device that acquires information on the running route of the vehicle 102 driven by the driver from the information acquisition start position to an information acquisition end position. Notably, the running route may be identified and stored based on a driving history of the driver, or may be identified and stored based on both the track of the vehicle 102 and the driving history of the driver.

In step S50, the CPU records the vehicle speed V detected by the vehicle speed sensor of the vehicle state sensor 70 and the vertical acceleration Gz detected by the vertical acceleration sensor of the vehicle state sensor 70 in the RAM together with information on the parking running route, particularly information on a position on the running route.

In step S60, the CPU determines whether or not the recording of information has been completed. In this step, the CPU may determine that the recording of information has been completed when the running route registration switch is turned from on to off or when a shift position of the transmission is changed to P range. When a negative determination is made, the control returns to step S30, and when an affirmative determination is made, the control proceeds to step S70. The position of the vehicle 102 when it is determined that the recording of information has completed is set as the information acquisition end position.

In step S70, the CPU stores in the storage device 18 the running route of the vehicle 102 from the information acquisition start position to the information acquisition end position together with surrounding information, based on the information recorded in the RAM.

In step S80, the CPU filters the vertical acceleration Gz recorded in the RAM and determines whether or not a magnitude of the vertical acceleration equal to or greater than a determination reference value Gzc has been detected. The determination reference value Gzc may be a positive constant, but may also be variably set according to the vehicle speed V so that the higher the vehicle speed V, the larger the determination reference value Gzc. When a negative determination is made, the control is once terminated, and when an affirmative determination is made, in step S90, the position where the magnitude of vertical acceleration equal to or greater than the determination reference value has been detected is stored in the storage device 18 as a specific point of the road surface displacement on the running route.

### <Example of Running Route Registration Control>

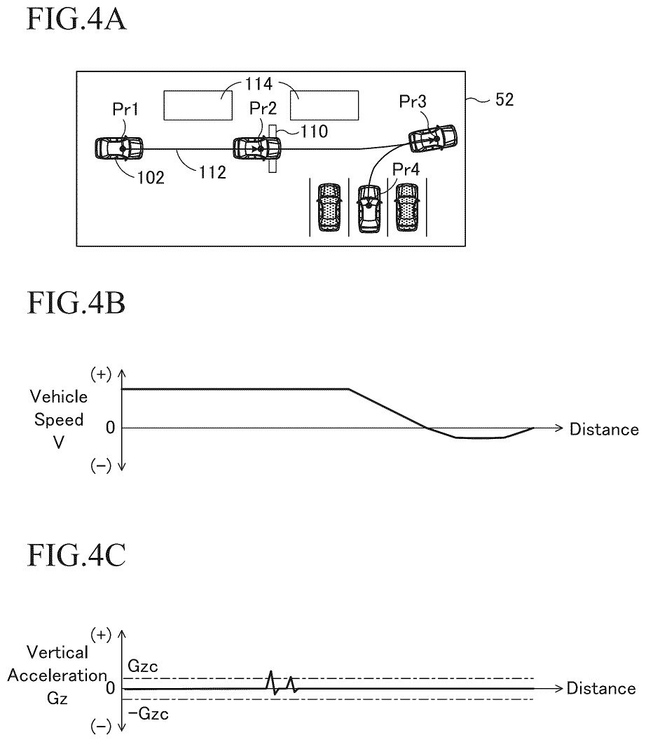

For example, FIGS. 4A to 4C show an example of the running route registration control when the vehicle 102 is parked. It is assumed that when the vehicle 102 is at a position Pr1, the running route registration switch of the setting operation device 16 is turned from off to on, and the running route registration control according to the flowchart shown in FIG. 2 is started. It is also assumed that the vehicle 102 passes over a speed bump 110 moving forward when it is at a position Pr2, stops once at a position Pr3, changes direction to reverse, and reverses to a position Pr4 (a parking position) and parks there.

Furthermore, it is assumed that the vehicle speed V and the vertical acceleration Gz change as shown in FIGS. 4B and 4C, respectively, and when front wheels of the vehicle 102 pass over the speed bump 110, a magnitude of the vertical acceleration Gz becomes equal to or exceeds the determination reference value Gzc. A running route 112 of the vehicle 102 from the position Pr1 to the position Pr4 via the positions Pr2 and Pr3 is the running route to be registered.

When the vehicle 102 is at the position Pr1, the determination in step S30 becomes affirmative, and when the vehicle 102 reaches the position Pr4 and is parked, the determination in step S60 becomes affirmative, and the running route 112 of the vehicle 102 is stored in the storage device 18 together with the surrounding information 114. Furthermore, since the determination in step S80 is affirmative, the position Pr2 where the magnitude of the vertical acceleration equal to or greater than the reference value is detected is stored in the storage device 18 as a specific point of a road surface displacement.

### <Driving Assistance Control (FIG. 3)>

Next, the driving assistance control in the embodiment will be described with reference to the flowchart shown in FIG. 3. The driving assistance control according to the flowchart shown in FIG. 3 is started by the CPU of the driving assistance ECU 10 when the driving assistance switch of the setting operation device 16 shown in FIG. 1 is turned from off to on, that is, when an automatic running command issued by the driver is received.

First, in step S110, as in step S10, the CPU identifies a present position (latitude and longitude) of the vehicle 102 based on information from the navigation device 80.

In step S120, the CPU outputs a command signal to the meter ECU 50 to cause the display device 52 to display a running route that corresponds to the present position of the vehicle 102 among the running routes stored in the storage device 18. When there are multiple running routes corresponding to the present position of the vehicle 102, the multiple running routes may be displayed.

In step S130, the CPU determines whether or not the driver has touched a “Yes” icon displayed on the display device 52 together with the running route, thereby determining whether or not the displayed running route has been approved. When a negative determination is made, step S130 is repeatedly executed, and when an affirmative determination is made, the control proceeds to step S140. Note that in a situation where multiple running routes are displayed, when a running route is selected by the driver and the image of the selected running route is touched, it is determined that the running route has been approved. When a negative determination is made, the control may be returned to step S120.

In step S140, the CPU sets a target running route based on the approved running route, and outputs a command signal to the meter ECU 50 to display the target running route on the display device 52. As will be described in more detail below, when the present position of the vehicle 102 is not on the approved running route, the target running route is set to include a merging route from the present position to the approved running route.

It is to be noted that when the driver wishes to park the vehicle at a position other than the end position of the target running route, such as when another vehicle is parked at the end position of the target running route displayed on display device 52, the driver may change the end position of the target running route by touching display device 52. Then, the target running route is corrected so that the running end position of the target running route becomes the changed running end position.

In step S150, the CPU determines whether or not the driver has touched a “Yes” icon displayed on the display device 52 together with the target running route, thereby determining whether or not the displayed target running route has been approved. When a negative determination is made, the control returns to step S140, and when an affirmative determination is made, the control proceeds to step S160.

In step S160, the CPU outputs a command signal to the drive ECU 20 and the like to control the running control device 90 to cause the vehicle 102 to run automatically so that the vehicle 102 runs along the target running route. The vehicle speed V may be controlled to a preset vehicle speed, or may be controlled to or close to a vehicle speed stored for each position on the approved target running route.

In step S170, the CPU determines whether or not there is a specific point of the road surface displacement, that is, whether or not a specific point of the road surface displacement is stored in the storage device 18 for the approved target running route. When a negative determination is made, the control proceeds to step S200, and when an affirmative determination is made, the control proceeds to step S180.

In step S180, the CPU determines whether or not the vehicle 102 has reached the specific point of the road surface displacement, thereby determining whether or not the vehicle is running in an area of the specific point (a position corresponding to the specific point). When a negative determination is made, the control proceeds to step S200, and when an affirmative determination is made, the control proceeds to step S190.

In step S190, the CPU outputs a command signal to the drive ECU 20, and the like, to control the running control device 90 so that the vehicle speed V when the front wheels of the vehicle 102 pass through the area of the specific point of the road surface displacement is reduced by a predetermined reduction amount ΔV.

The reduction amount ΔV in the vehicle speed is variably set according to the vehicle speed during the automatic running and a magnitude of the detected vertical acceleration Gz of the vehicle 102 so that the reduction amount ΔV in the vehicle speed is larger the higher the vehicle speed during the automatic running and the larger the magnitude of the detected vertical acceleration Gz of the vehicle. In particular, the reduction amount ΔV may be variably set so that the magnitude of the vertical acceleration Gz of the vehicle 102 when the front wheels of the vehicle pass through the specific point of the road surface displacement is equal to or less than a reduction reference value Gzr (a positive constant) which is smaller than the determination reference value Gzc.

The vehicle speed V is reduced from before the front wheels of the vehicle 102 reach the specific point of the road surface displacement until after they have passed the specific point of the road surface displacement. When a specific point of the road surface displacement for rear wheels of the vehicle 102 is also stored in the storage device 18, the running control device 90 may be controlled so that the vehicle speed V is reduced by a predetermined reduction amount ΔV when the rear wheels pass through the specific point of the road surface displacement.

In addition, when the specific point of the road surface displacement for the rear wheels of the vehicle 102 is also stored in the storage device 18, the vehicle speed V may be reduced from before the front wheels reach the specific point of the road surface displacement to after the rear wheels have passed the specific point of the road surface displacement. Furthermore, the reduction in vehicle speed V may be notified by displaying it on the display device 52 or by an audio announcement.

In step S200, the CPU determines whether or not the present position of the vehicle 102, which is identified based on information from the navigation device 80, for example, is the running end position, thereby determining whether or not the vehicle 102 has reached the running end position. When a negative determination is made, the control returns to step S160, and when an affirmative determination is made, the control proceeds to step S210.

In step S210, the CPU outputs a command signal to the meter ECU 50 to display on the display device 52 that the vehicle 102 has reached the running end position. This allows the driver to switch the driving assistance switch of the setting operation device 16 from on to off.

### <Example of Driving Assistance Control>

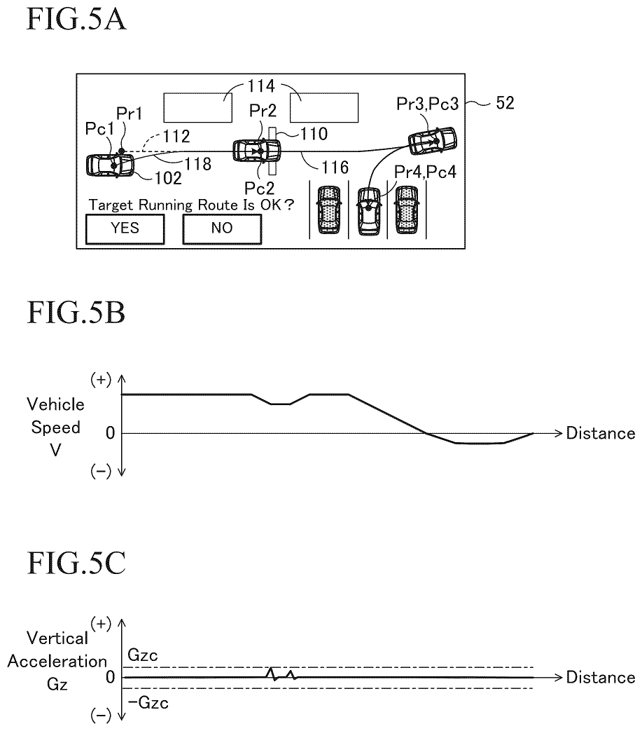

For example, FIGS. 5A to 5C show an example of the driving assistance control when parking the vehicle 102. It is assumed that the driving assistance switch of the setting operation device 16 is turned from off to on when the vehicle 102 is at a position Pc1, and the driving assistance control according to the flowchart shown in FIG. 3 is started.

First, the present position Pc1 of the vehicle 102 is identified based on information from the navigation device 80 (S110), and a running route 112 corresponding to the present position of the vehicle among the running routes stored in the storage device 18 is displayed on the display device 52 (S120).

When the displayed driving route is approved (S130), the target running route 116 is set based on the approved running route, and a target running route is displayed on the display device 52 (S140). When the running start position, i.e., the present position Pc1 of the vehicle 102 at the start of driving assistance, is not on the approved running route 112, the target running route 116 is set to include a merging route 118 leading from the running start position to the running route 112 (S140).

When the target running route 116 is approved (S150), the running control device 90 is controlled so that the vehicle 102 runs along the target running route, and the vehicle 102 moves by the automatic running through the positions Pc2 and Pc3 corresponding to the positions Pr2 and Pr3, respectively, to the running end position Pc4 corresponding to the position Pr4 (S160). When the vehicle 102 reaches the running end position Pc4 (S200), the display device 52 displays a message indicating that the vehicle has reached the running end position (S210).

If there is a specific point of the road surface displacement such as a speed bump 110, an affirmative determination is made in step S170. The running control device 90 is controlled so that the vehicle 102 runs through the area of the specific point of the road surface displacement (the position Pc2 corresponding to the position Pr2) (S180), and the vehicle speed V is reduced by the predetermined reduction amount ΔV when at least the front wheels pass through the specific point of the road surface displacement (S190).

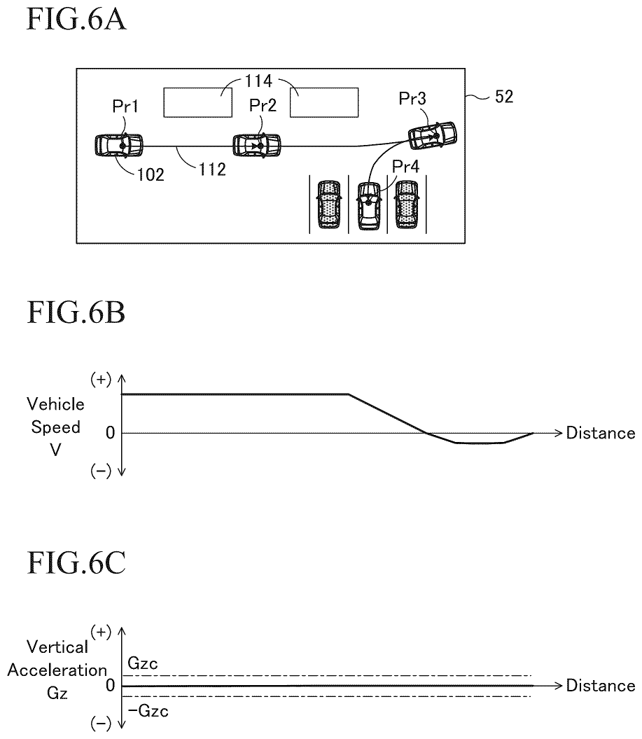

If there is no specific point of the road surface displacement such as the speed bump 110, a negative determination is made in step S170, and the vehicle speed is not reduced (S190). FIGS. 6A to 6C shows an example of the driving assistance control when there is no specific point of the road surface displacement.

As can be seen from the above explanation, according to the embodiment, when the vertical acceleration sensor as a detection device detects a magnitude of vertical acceleration Gz equal to or greater than the reference value Gzc while the vehicle 102 is being driven by the driver, the position where the magnitude of the vertical acceleration equal to or greater than the reference value is detected is stored in the storage device 18 as a specific point Pr2 of the road surface displacement together with information on the running route 112. Furthermore, the running control device 90 is controlled so that the vehicle speed V is reduced by the reduction amount ΔV when the vehicle 102 passes through the point Pc2 corresponding to the specific point during the automatic running.

Therefore, when there is a specific point, the vehicle speed V is reduced when the vehicle passes through the point Pc2 corresponding to the specific point Pr2 during the automatic running, so that an impact load input to a vehicle body from a road surface via the wheels when the vehicle passes through the point corresponding to the specific point is reduced and the degree of vibration of the vehicle body is reduced as compared to where the vehicle speed is not reduced. Therefore, the risk of occupants feeling uncomfortable due to vibration of the vehicle body can be reduced as compared to conventional devices.

According to the embodiment, the reference value Gzc is variably set according to the vehicle speed V so that the reference value Gzc is larger as the vehicle speed during driving of the vehicle by the driver increases. Therefore, it is possible to preferably determine whether or not the vertical displacement of the road surface at the specific point is large, as compared to where the reference value is constant regardless of the vehicle speed.

Furthermore, according to the embodiment, the reduction amount ΔV in the vehicle speed when the vehicle passes through the point Pc2 corresponding to the specific point Pr2 during the automatic running becomes larger the higher the vehicle speed V during the automatic running is, and/or the larger the magnitude of the vertical acceleration Gz of the vehicle detected by the vertical acceleration sensor is. Therefore, as compared to where the reduction amount in vehicle speed is constant, it is possible to preferably reduce an impact load input to the vehicle body when passing through the position corresponding to the specific point.

Furthermore, according to the embodiment, when the running start position Pc1 is not on the running route 112 stored in the storage device 18, the target running route 116 is set so as to include a merging route 118 leading from the running start position to the running route stored in the storage device. Therefore, even when the running start position is not on the running route stored in the storage device, the vehicle can be moved to the running end position along the target running route by the automatic running.

Furthermore, according to the embodiment, at least the information acquisition start position Pr1 can be identified based on the position of the vehicle 102 acquired by the GPS device of the navigation device 80, and the running route 112 of the vehicle can be identified based on at least one of the track of the vehicle acquired by the GPS device and the driving history of the driver.

Furthermore, according to the embodiment, when the specific point Pr2 is stored in the storage device 18 together with the information on the running route 112 used to set the target running route 116, the target running route, the specific point, and the present position of the vehicle are displayed on the display device 52. Therefore, the driver can be aware in advance that the vehicle speed will be reduced when the vehicle passes through a position corresponding to the specific point during the automatic running, reducing the risk of the driver feeling uncomfortable due to an automatic reduction in vehicle speed.

Although the present disclosure has been described in detail with reference to the specific embodiment, it will be apparent to those skilled in the art that the present disclosure is not limited to the above-described embodiment, and various other embodiments are possible within the scope of the present disclosure.

For example, in the above-described embodiment, in step S190, the reduction amount ΔV in the vehicle speed becomes larger as the vehicle speed during the automatic running becomes higher and as a magnitude of the vertical acceleration of the vehicle detected by the vertical acceleration sensor serving as the detection device becomes larger. However, the reduction amount ΔV in the vehicle speed may be variably set in response to only one of the vehicle speed during the automatic running and the magnitude of the vertical acceleration of the vehicle detected by the detection device.

Further, in the above-described embodiment, the information acquisition start position and the information acquisition end position are the parking start position and the parking end position, respectively, and the driving assistance control is parking assistance control. However, the driving assistance control may be starting driving assistance control from a parking position, or assistance control other than parking assistance control and starting driving assistance control, or a range of driving assistance control may even be constant.

Furthermore, if the vehicle is equipped with variable damping coefficient shock absorbers provided for the wheels, damping coefficients may be reduced in addition to or instead of reducing the vehicle speed.

What is claimed is:

1. A driving assistance device for a vehicle, comprising a route information acquisition device that acquires information on a running route along which the vehicle is driven by a driver from an information acquisition start position to an information acquisition end position based on an information acquisition command from the driver; a storage device that stores the information on the running route acquired by the route information acquisition device; a running control device that controls running of the vehicle; and an electronic control unit that controls the route information acquisition device, the storage device, and the running control device, and the electronic control unit is configured, upon receiving an automatic running command from the driver, to set a target running route from a present position of the vehicle to a running end position based on the information on the running route stored in the storage device, and to control the running control device to move the vehicle by automatic running so that the vehicle runs along the target running route, wherein
the driving assistance device includes a detection device that detects a vertical acceleration of the vehicle, and the electronic control unit is configured to, when the detection device detects a magnitude of the vertical acceleration equal to or greater than a reference value while the vehicle is being driven by a driver, store a position where the magnitude of the vertical acceleration equal to or greater than the reference value is detected in the storage device as a specific point of road surface displacement together with information on the running route, and to control the running control device so that a vehicle speed is reduced when the vehicle passes through a position corresponding to the specific point during the automatic running.

2. The driving assistance device for a vehicle according to claim 1, wherein the reference value is variably set according to the vehicle speed so that the higher the vehicle speed when the vehicle is driven by the driver, the larger the reference value becomes.

3. The driving assistance device for a vehicle according to claim 1, wherein a reduction amount in vehicle speed when the vehicle passes through the position corresponding to the specific point during the automatic running is variably set according to at least one of the vehicle speed during the automatic running and the magnitude of the vertical acceleration of the vehicle detected by the detection device so that the reduction amount in vehicle speed is larger as the vehicle speed during the automatic running is higher and the magnitude of the vertical acceleration of the vehicle detected by the detection device is larger.

4. The driving assistance device for a vehicle according to claim 1, wherein the electronic control unit is configured to, when a running start position of the automatic running is not on the running route stored in the storage device, set the target running route to include a merging route from the running start position to the running route stored in the storage device.

5. The driving assistance device for a vehicle according to claim 1, wherein the route information acquisition device includes a GPS device, and the electronic control unit is configured to identify at least the information acquisition start position based on a position of the vehicle acquired by the GPS device, and to identify the running route of the vehicle based on at least one of a track of the vehicle acquired by the GPS device and driving history of the driver.
